(19) United States
(12) Patent Application Publication
(10) Pub. No.: US 2009/0065276 A1
(43) Pub. Date: Mar. 12, 2009

(54) Hybrid Vehicle

(76) Inventors: Peter Birke, Glienicke/Nordbahn (DE); Michael Keller, Baden-Baden (DE)

Correspondence Address: CONTINENTAL TEVES, INC., ONE CONTINENTAL DRIVE, AUBURN HILLLS, MI, 48326-1581, US

(21) Appl. No.: 12/282,521

(22) PCT Filed: Jan. 27, 2007
(86) PCT No.: PCT/DE07/00150

§ 371 Date: Sep. 11, 2008

(30) Foreign Application Priority Data
Mar. 20, 2006 (DE) 102006013133.9

(51) Int. Cl. B60L 11/00

(52) U.S. Cl. 180/65.275

(57) ABSTRACT

A hybrid motor vehicle (1) with an electric energy storage unit (2) is designed to enable the improvement of the power output and to increase the service life of the energy storage unit (2). For this purpose, thermal insulation (4) is provided according to the invention.

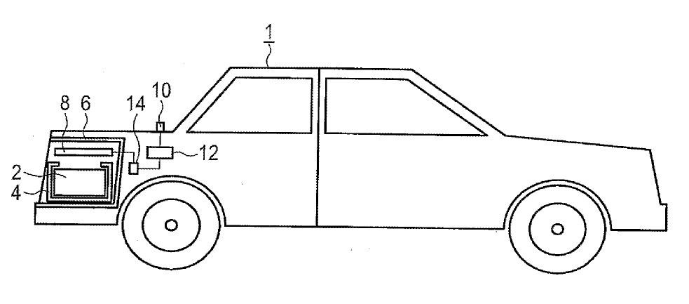

### BACKGROUND OF THE INVENTION

The invention relates to a hybrid motor vehicle with an electric energy storage unit, in particular with an NiMH or Li-ion rechargeable battery.

The combination of different drive principles or different energy sources for one drive task within an application is known as a hybrid drive of a motor vehicle. A differentiation is made between different hybridisation systems, such as micro hybrid, with which a start-stop operation is made possible, wherein for this purpose, the hybrid system works with the existing on-board network. In the micro hybrid system, the internal combustion engine can be switched off when the motor vehicle is at a standstill, and re-started without any noticeable time delay when the vehicle starts moving again. This enables significant fuel savings, for example when the hybrid vehicle is used in typical urban stop-and-go traffic.

The hybrid system may further be embodied as a mild hybrid, when an alternative drive form is used solely to support the main drive form. A full hybrid is the embodiment of a hybrid system with which the drive forms available are capable of acting autonomously. A further extension of the hybrid system is realised in the form of a “power hybrid”.

A version of the hybrid motor vehicle is realised as a combination of an internal combustion engine and one or more electric motor(s). The internal combustion engine can be operated to a very high degree of efficiency with the hybrid drive. Any excess energy which is produced is used to electrically charge the battery via a generator. During acceleration, the internal combustion engine and the electric motor operate together. When the same acceleration is achieved, therefore, a smaller internal combustion engine can be provided. The reduction in size of the internal combustion engine here partially compensates for the additional weight of the hybrid aggregates.

A hybrid motor vehicle comprises at least one energy storage unit. The energy from this energy storage unit can be used to start the internal combustion engine, for the electric consumers in the motor vehicle and for acceleration procedures.

When braking and in coasting mode, part of the braking energy is fed back into the battery, a process referred to as recuperation. This recovery contributes towards a reduction in consumption, in particular in urban traffic and when driving downhill. A further advantage of this design is that no conventional starting engine is required, since the electric motor can perform this function.

An internal combustion engine provides a high torque in a specific engine speed range. By contrast, the electric motor already provides the maximum torque when the vehicle starts to move, and reduces the torque at a higher motor speed. By combining the two motors, the better torque respectively can be used, and with current designs, the motor vehicle can accelerate approximately 10% to 30% faster.

Furthermore, the operation of the internal combustion engine in a more favourable range of operation leads to lower emissions. This applies both to toxic emissions and to the release of the greenhouse gas CO₂ as a direct result of the lower fuel consumption.

Hybrid motor vehicles typically achieve a lower maximum speed due to the less powerful internal combustion engine, which in contrast to conventional motor vehicles no longer needs to be dimensioned for all driving states. This driving state, such as driving fast on the motorway, is the only situation in which typically, a higher motor power is required over a longer period of time, which can only be provided by the internal combustion engine. In this operating phase, the hybrid mechanisms do not have a direct effect, but by downsizing the internal combustion engine and optimising the thermal degree of efficiency (Atkinson principle), consumption savings can also be attained here. The acceleration behaviour for which both motors are responsible is not affected by this.

Several versions of the design of a motor vehicle with a hybrid drive and the combination of an internal combustion engine with one or more electric motor(s) are possible. In one possible version, the hybrid motor vehicle has a petrol engine and an electric motor, which are coupled via a planetary gear set to the drive axis. Operating states in which the internal combustion engine only has a low degree of efficiency, for example when the vehicle starts to move or in urban traffic, are adopted by the electric motor with a far greater degree of efficiency. When required, the internal combustion engine can also be completely switched off. When driving with a constant load, such as in “marching” mode, the petrol engine drives the motor vehicle alone, while the battery is simultaneously charged by the petrol engine via the generator. With a heavier load, the motor vehicle is driven by both motors together. Energy can be recuperated in motors brake mode. The energy savings as opposed to petrol-driven motor vehicles of the same class are up to 30%, depending on the driving cycle. A version with a recharging option on the mains supply and a greater electrical range has to date only been realised as a prototype (plug-in hybrid).

In another design, for example in order to increase driving performance over difficult terrain, the drive of the hybrid motor vehicle comprises, alongside the petrol engine, two electric motors, with one each on the front and on the rear axle. The overall power of a model of this type can total over 300 kW according to the current design, wherein the force distribution is for example designed in such a manner that the petrol engine contributes 47% to the overall power, the electric motor for which the drive acts on the front axle contributes 38%, and the electric motor which is connected to the rear axle contributes 15%. However, the engine powers cannot be added together, since the battery can only deliver a restricted level of power.

A further design of the drive system provides that the electric motor does not rest on an axle, but is coupled to a drive chain between the motor and the gears. As a result, significantly less technology is required as opposed to the embodiments described above, which in turn leads to lower power requirements.

Alongside the aforementioned advantages which positively influence the drive properties of the motor vehicle, one further technical advantage arises from the combination of the internal combustion engine with one or more electric motors as a drive is for example that secondary systems such as driving stabilisation systems, ESP/ABS systems or similar can be operated significantly more efficiently. For example, an intervention in the stabilisation of the driving situation occurs approx. ten times faster than with an ABS/ESP system with a standard hydraulic aggregate when the electric motors are coupled with an ESP system, so that driving safety is therefore increased accordingly.

An electric energy storage unit with a high capacity is required in order to drive a hybrid motor vehicle, which also needs to have the longest possible service and application life.

The object of the invention is to provide a hybrid motor vehicle of the aforementioned type which further improves the power output of an electric energy storage unit, and which increases service life.

### SUMMARY OF THE INVENTION

This object is attained by the invention by means of the fact that the electric energy storage comprises thermal insulation.

The invention is based on the consideration that a motor vehicle is used all year round. Furthermore, at the point in time of production, the geographic area of use cannot yet be recognised. For this reason, the ambient conditions at the point in time when the motor vehicle will be used, including the outside temperature, cannot be foreseen and typically change constantly during the service life of the motor vehicle.

Since an electric energy storage unit is used in a hybrid motor vehicle, the power output of which, together with the length of service life, depends on its immediate ambient conditions, in particular on the temperature, the latter should be kept as constant as possible at a level which is particularly advantageous for the energy storage unit.

In order that the cooling for the energy storage unit remains constant when the hybrid motor vehicle is at a standstill and when the drive motor is switched off, particularly in high outside temperatures and/or thermal radiation from the internal combustion engine, the cooling elements are advantageously designed to be able to function independently of the drive of the hybrid motor vehicle in that they are electrically connected to the energy storage unit in order to secure their energy supply.

In order to be able to bring the energy storage unit in the hybrid motor vehicle into the most advantageous range possible from a thermal point of view, and to be able to maintain its immediate ambient temperature at a constant, specified temperature which is particularly suitable for the energy storage unit, the hybrid motor vehicle advantageously comprises a holding compartment for the energy storage unit which can be cooled or heated as required.

In order to be able to specify the respective current ambient conditions in which the hybrid motor vehicle is operated, and thus to record the parameters for the thermal treatment of the energy storage unit and to determine a set value for the temperature regulation of its immediate ambient temperature, the hybrid motor vehicle advantageously contains an evaluation unit which records and evaluates the ambient temperature by means of a temperature sensor which is advantageously provided outside on the hybrid motor vehicle.

In order to take into account the set value which is calculated by the evaluation unit and which depends on the ambient temperature of the hybrid motor vehicle and on the temperature range of the energy storage unit which is particularly advantageous, the hybrid motor vehicle advantageously comprises a control unit which controls the temperature of the holding compartment and thus also the immediate ambient temperature for the energy storage unit.

The advantages attained with the invention are in particular that the opportunity is given to provide over a broader operating spectrum and a longer period of time a constant output of the energy storage unit for hybrid applications. Furthermore, the improved temperature range in which the energy storage unit is kept leads to an increase in service life length.

An embodiment of the invention will now be explained with reference to a drawing.

### BRIEF DESCRIPTION OF THE DRAWING

The FIGURE in said drawing shows a cross-section of a hybrid motor vehicle with a holding compartment for the energy storage unit.

### DETAILED DESCRIPTION OF THE DRAWING

A hybrid motor vehicle 1, the drive unit of which comprises an internal combustion engine and an electric motor, not shown, comprises at least one electric energy storage unit 2. This is housed in a suitable position in the hybrid motor vehicle 1 and is electrically connected with the electric motor in order to drive said motor.

Usually, the energy storage unit 2 is fitted in a motor vehicle, in particular a hybrid motor vehicle 1, close to the drive unit without taking into account thermal parameters. Since, however, both the capacity and the service life of the energy storage unit 2 depend on the ambient temperature of the energy storage unit 2 and during operation of the hybrid motor vehicle 1, temperature fluctuations can occur which depend on the mode of use, the season and the weather, thermal insulation 4 of the energy storage unit 2 can be provided on the energy storage unit 2 which can for example be integrated into the holding compartment 6 which is provided for the energy storage unit 2.

Due to the mode of functioning of the battery cells of an energy storage unit 2, these cells warm up by discharging, i.e. the individual temperature of the energy storage unit 2 increases when energy is removed in order to operate the electric motor in the hybrid motor vehicle 1. Furthermore, the battery cells of an accumulator warm up during the charging process, for example when the energy storage unit 2 is charged while the hybrid motor vehicle 1 is in operation. In order to prevent the temperature from rising above a value which damages the energy storage unit, and in order to maintain a constant capacity and thus the power to be emitted despite the negative influence of the galvanic process in the energy storage unit 2 due to the increased temperature, and in order to avoid a heat build-up in the holding compartment 6 when the drive unit of the hybrid motor vehicle 2 is switched off, a number of cooling elements 8 are integrated into the holding compartment 4 which enable the energy storage unit 2 to be cooled regardless of whether the drive unit of the hybrid motor vehicle 1 is being operated or not, by drawing their energy supply directly from the energy storage unit 2.

These cooling elements 8 can be integrated into the holding compartment 6 of the energy storage unit 2. The entire holding compartment 6 can also be provided as a cooling compartment when with the ambient conditions to be anticipated for the operation of the hybrid motor vehicle 1, temperatures occur which lie solely above a minimum value for the temperature value which underlies the energy storage unit 2.

If a prior determination of a temperature range is not possible, the temperature-influencing element of the holding compartment 6 should not only be designed as a cooling, but also as a heating element. For the cooling element 8, this means the option of selecting the appropriate setting as required for use as a cooling or heating element for the energy storage unit 2.

The individual temperature of the energy storage unit 2, i.e. the cooling or heating in relation to a specified, optimum value, is based both on the influence caused by energy emission and/or charging and on the ambient temperature. In order to record this ambient temperature, and to evaluate it for the holding compartment 6 and/or the energy storage unit 2, the hybrid motor vehicle 1 comprises a temperature sensor 10 and an evaluation unit 12 which is connected with said sensor.

The information from the evaluation unit 12 is generally processed in a control unit 14 which controls the temperature in the holding compartment 6 via the cooling/heating element 8 with the specification of a particularly suitable pre-set temperature for the energy storage unit 2.

1-7. (canceled)

8. A hybrid motor vehicle comprising:
an energy storing unit (2);
thermal insulation (4) for insulating the energy storing unit; and
one or more cooling elements (8) for cooling the energy storage unit (2), wherein the one or more cooling elements (8) act independent of operation of the hybrid motor vehicle (1).

9. The hybrid motor vehicle of claim 8, wherein the energy storing unit (2) is a NiMH- or Li-ion accumulator battery.

10. The hybrid motor vehicle of claim 8, further comprising a holding compartment (6) for the energy storage unit (2).

11. The hybrid motor vehicle of claim 10, wherein the holding compartment is a cooling compartment.

12. The hybrid motor vehicle of claim 10, wherein the holding compartment has a number of heating elements (8).

13. The hybrid motor vehicle of claim 10, further comprising a control unit (14) for controlling a temperature of the holding compartment (6).

14. The hybrid vehicle of claim 13, further comprising an evaluation unit (12) for determining an ambient temperature.
